(19) United States
(12) Patent Application Publication
(10) Pub. No.: US 2018/0130114 A1
(43) Pub. Date: May 10, 2018

(54) ITEM RECOGNITION

(71) Applicant: Accenture Global Solutions Limited, Dublin (IE)

(72) Inventors: Chris Hawkins, Dublin (IE); Allison Youngdahl, Mountain VIew, CA (US); David H. Nguyen, Santa Clara, CA (US); Leeann Chau Tuyet Dang, San Jose, CA (US); David T. Nguyen, San Jose, CA (US); Charlotte Naylor, Dublin (IE); Maya Agaskar, Dublin (IE)

(21) Appl. No.: 15/343,424

(22) Filed: Nov. 4, 2016

(51) Int. Cl. G06Q 30/06; G06T 7/00; G06K 9/62; G06K 9/66; G06Q 50/00

(52) U.S. Cl. CPC G06Q 30/0631; G06T 7/0004; G06K 9/6267; G06F 17/30268; G06K 9/66; G06Q 50/01; G06Q 30/0623; G06K 9/6215

(57) ABSTRACT

Methods, systems, and apparatus, including computer programs encoded on computer storage media, for using image data of an item to recognize the item. A method may include receiving device identification information for a first device, an image, and an account identifier associated with the image, determining, using the account identifier, account data, determining, using the device identification information, a particular set of one or more items associated with the first device, determining, using image recognition, that the image likely shows a first item in the particular set, identifying, from among the particular set and using the account data and the last determination, a second item that is different from the first item and that includes a second attribute value that is the same as a first attribute value for the first item, and providing, to a second device, instructions for presentation of information about the second item.

### TECHNICAL FIELD

This disclosure generally relates to computer-implemented systems, methods, and other techniques for recognition of an item.

### BACKGROUND

An image recognition system may analyze an image to identify an item shown in the image. For instance, an image recognition system may use a neural network to determine a type of item shown in an image, such as a tree, a car, a person, or an item.

### SUMMARY

A system may use visual object recognition to detect items depicted in an image. The system may prune a search space using item information for an establishment associated with the image. For instance, the system may receive the image from a device physically located in the establishment, determine a list of items associated with the establishment, and compare data, e.g., features, for items depicted the image with data, e.g., features, for the items on the list of items. The system may determine whether the items depicted in the image are included on the list of items using the comparison. When an item depicted in the image is included in the list of items, the system may determine attributes for the item. In some implementations, the system may determine a recommended item from the list of items using the determined attributes for the item depicted in the image.

In some implementations, the system may determine an identity of a person holding the item and prune a search space using data for the person. For example, the system may obtain information about the person from a social network profile and determine the item or the recommended item or both using data from the social network profile. The person may interact with the device, e.g., a touchscreen included in the device, to obtain more information about the recommended item, the depicted item, or both.

In general, one innovative aspect of the subject matter described in this specification can be embodied in methods that include the actions of receiving, from a first device, (i) device identification information for the first device, (ii) an image that was captured by the first device, and (iii) an account identifier identifying a user account that is associated with the image; determining, using the account identifier, account data for the user account; determining, based on the first device identification information, a particular set of one or more items associated with the first device; determining, using image recognition with the particular set of one or more items, that the image likely shows a first item in the particular set of one or more items; using the account data and in response to the determination that the image likely shows the first item in the particular set of one or more items, identifying, from among the particular set of one or more items, a second item in the particular set of one or more items that is different from the first item for which a first attribute value for the first item is the same as a second attribute value for the second item; and providing, to a second device, instructions for presentation of information about the second item.

Some implementations of this and other aspects include corresponding systems, apparatus, and computer programs, configured to perform the actions of the methods, encoded on computer storage devices. A system of one or more computers can be so configured by virtue of software, firmware, hardware, or a combination of them installed on the system that in operation cause the system to perform the actions. One or more computer programs can be so configured by virtue of having instructions that, when executed by data processing apparatus, cause the apparatus to perform the actions.

These other implementations may each optionally include one or more of the following features. The method may include identifying, using the account data for the user account, a subset of the particular set of one or more items. Determining, using image recognition with the particular set of one or more items, that the image likely shows the first item in the particular set of one or more items may include determining, using image recognition with the subset of the particular set of one or more items, that the image likely shows the first item in the subset of the particular set of one or more items. Identifying, from among the particular set of one or more items, the second item in the particular set of one or more items may include selecting, from among the subset of the particular set of one or more items and using the account data, the second item. The method may include generating, using the account data, the instructions for presentation of information about the second item.

In some implementations, providing, to the second device, the instructions for presentation of information about the second item may include providing, to the second device, the instructions for presentation of information about the first item and the second item. The method may include, in response to determining that the image likely shows the first item in the particular set of one or more items, determining to make a recommendation for another item. Identifying, from among the particular set of one or more items, the second item as a recommended item in the particular set of one or more items may be responsive to determining to make a recommendation for another item. Determining, based on the device identification information, the particular set of one or more items associated with the first device may include determining, based on the device identification information, the particular set of one or more items that are available to patrons of a particular establishment with which the first device is registered. The user account may be an account for a social networking service.

In some implementations, identifying, from among the particular set of one or more items, the second item in the particular set of one or more items that is different from the first item may include identifying, from among the particular set of one or more items, the second item in the particular set of one or more items that is different from the first item using data for one or more social networking accounts that are each connected with the user account. Identifying, from among the particular set of one or more items, the second item in the particular set of one or more items that is different from the first item may include identifying, from among the particular set of one or more items, the second item in the particular set of one or more items that is different from the first item using activity data for the user account for the social networking service. Providing, to the second device, instructions for presentation of information about the second item may include providing, to the first device, instructions for presentation of information about the second item.

In some implementations, providing, to the second device, instructions for presentation of information about the second item may include providing, to the second device that is a separate device from the first device, instructions for presentation of information about the second item. The method may include receiving, from the first device, data that identifies a particular device to which a system should provide a recommendation for another item. Providing, to the second device, instructions for presentation of information about the second item may include providing, by the system to the particular device, instructions for presentation of information about the second item. Receiving, from the first device, (i) the device identification information for the first device, (ii) the image that was captured by the first device, and (iii) the account identifier identifying the user account that is associated with the image may include receiving, by the system, the data that identifies the particular device to which the system should provide a recommendation for another item.

The subject matter described in this specification can be implemented in particular embodiments and may result in one or more of the following advantages. For example, one or more of the systems, techniques, or both, described herein for item recognition may increase efficiency of a search system. For instance, a search system may use fewer computer resources, e.g., memory or processing resources or both, by reducing a search space using a set of items associated with a particular device, a set of items associated with a user account, a set of items for user accounts connected to the user account on a social networking service, or a combination of two or more of these. In some implementations, the systems and techniques described below may provide a personalized recommendation to a user using account data for the user, items available from an establishment at a physical location of a user, or both.

The details of one or more embodiments of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is an example environment for recognizing an item in an image using data for an establishment and providing recommendations for alternative items.

FIG. 2 is a flowchart of an example process for determining an item recommendation.

FIG. 3 is a diagram of example computing devices.

### DETAILED DESCRIPTION

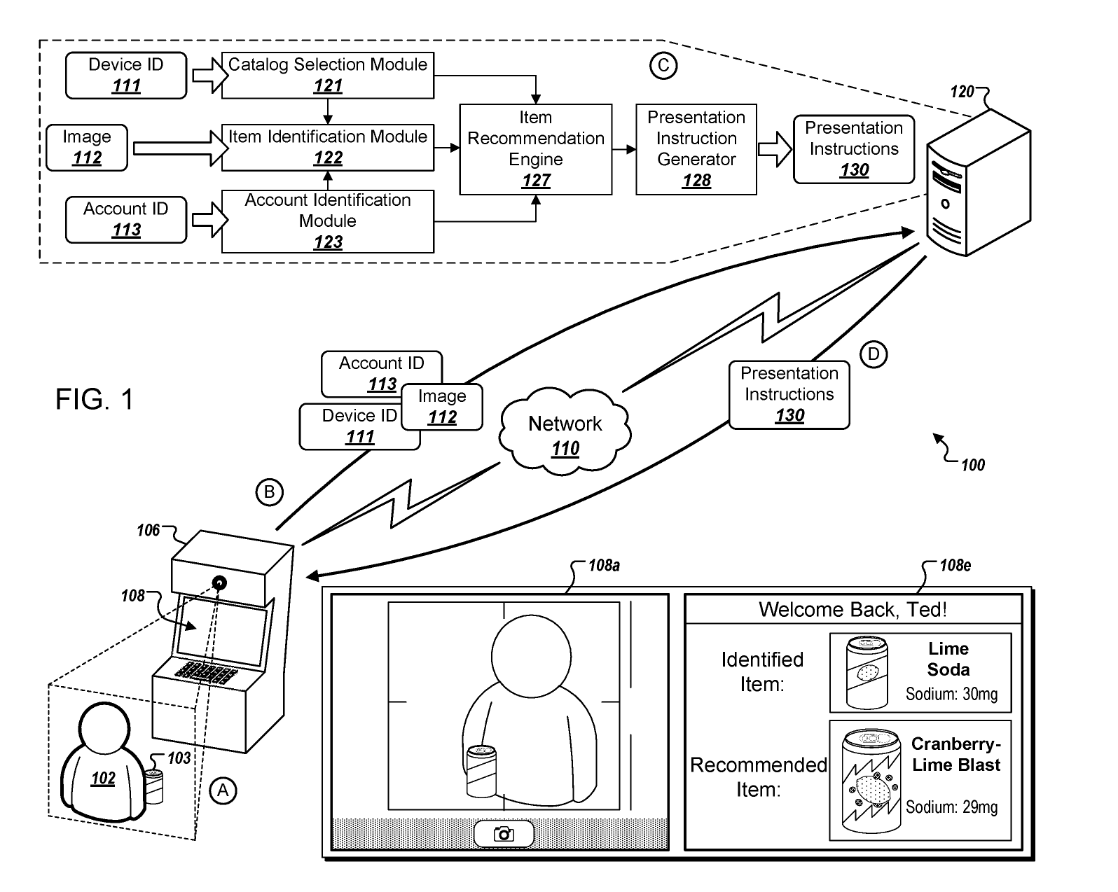

FIG. 1 is an example environment 100 for recognizing an item in an image using data for an establishment and providing recommendations for alternative items. The environment 100 includes a computing system 120 in communication with a client device 106 over a network 110. Devices within the environment 100 may transmit data in time-sequenced stages “A” to “D.” The client device 106 may display a user interface 108 in various stages, labeled as user interfaces 108a to 108e. Briefly, and as described in further detail below, the computing system 120 may receive a device identifier (“ID”) 111, an image 112, and an account ID 113 from the client device 106, use the device ID 111, the image 112, and the account ID 113 to identify an item depicted in the image 112 and also identify another item that is different from the item depicted in the image 112. The computing system 120 provides, to the client device 106, presentation instructions 130 that include information about the other identified item.

The computing system 120 may, for instance, represent one or more servers in one or more locations that are accessible to an entity that is associated with an establishment, e.g., an owner or partner of an establishment within which the client device 106 is physically located. In some examples, the computing system 120 may include a catalog selection module 121, an item identification module 122, an account identification module 123, an item recommendation engine 127, and a presentation instruction generator 128. Although depicted as a singular system, the architecture of computing system 120 may be implemented using one or more networked computing devices. The networked computing devices may be physical computing devices, virtual machines, or both.

The client device 106 may be a kiosk or other workstation that is associated with at least one establishment, e.g., a restaurant, store, shopping mall, movie theatre, tavern, club, supermarket, etc., and may include one or more computing devices. In some examples, the client device 106 may include or be implemented as a mobile computing device, such as a smartphone, personal digital assistant, tablet, laptop, cellular telephone, drone, camera, and the like. The client device 106 may, through execution of an application that is installed on the client device 106, display a user interface 108. The application may be a web browser, an item information application, or another type of application.

The client device 106 includes one or more input devices. In some examples, the client device 106 may include or communicate with a camera or other imaging sensor capable of capturing pictures. In some examples, the client device 106 includes a touch screen interface that receives user input.

The client device 106 accesses the network 110 using a wired connection, a wireless connection, or both, e.g., when the client device 106 communicates with another device that is connected to the network 110, for sending data to and receiving data from the computing system 120. In some implementations, the network 110 includes one or more networks, such as a local area network, a wide area network, and/or the Internet. One or more of the networks in the network 110 may be wireless, such as a cellular telephone network, a Wi-Fi network, or another appropriate type of wireless network.

In some examples, the client device 106 and the computing system 120 may be included in a single device or the same group of devices. For example, a kiosk may perform the steps described here for the client device 106 and for the computing system 120.

In stage A, the client device 106 may capture or otherwise obtain an image 112. For instance, the client device 106 may use an integrated camera to capture the image 112. In some examples, the camera may be external to and connected with the client device 106. The client device 106 may capture the image in response to determining that one or more items are approaching the client device 106, are within a specific distance from the client device 106, or both, as determined by one or more proximity sensing components of the client device 106. In some implementations, the client device 106 may receive data for the image from another device, e.g., from a mobile device such as a smart phone of a user 102.

In the example of FIG. 1, in stage A, the client device 106 may detect the presence of a user 102 holding an item, such as a soda can 103, using one or more proximity sensing components included in the client device 106. The item may be an appropriate type of item, such as a toy, another food product, or a tool. In response to determining that the soda can 103 is less than a threshold distance away from the client device 106, the client device 106 may, for instance, capture one or more images of the soda can 103 using a camera that is integrated into the client device 106. In doing so, the client device 106 may display a screen, such as the user interface 108a. The user interface 108a may indicate to a user of the client device 106, such as the user 102, that one or more images are being captured or will be captured. In some instances, the user interface 108a may include user interface elements that allow users of the client device 106 to review captured images, instruct the client device 106 to retake images, edit captured images, and the like.

In some examples, the client device 106 may provide proximity sensing functionality, or may detect items in its vicinity by periodically capturing images using the camera. The client device 106 may analyze the captured images for indication movements and other changes within a field of view of a camera for the client device 106. In some implementations, such images may be captured based on other types of interactions between users and the client device 106. For instance, the client device 106 may use its camera to capture one or more images in response to input received through one or more user interfaces of the client device 106, such as touch input or voice input, in response to data received through one or more communication interfaces of the client device 106, such as radio identifiers broadcasted by smartphones and other computing devices belonging to one or more users within the vicinity of the client device 106, and the like.

The client device 106 may determine the account ID 113. For instance, the client device 106 may include a touch screen display, or another input device, that receives the account ID 113 as input. In some examples, the client device 106 includes a card reader or a radio frequency identifier reader that receives input from an account card, such as a club membership card, a customer loyalty card, or another type of card. The client device 106 may use the input from the card reader or the radio frequency identifier reader to determine the account ID 113.

In stage B, the computing system 120 receives a device ID 111, an image 112, and an account ID 113 from the client device 106 over network 110. The device ID 111 may, for instance, include information that identifies the client device 106. The device ID 111 may be indicative of the establishment within which the client device 106 is located. For instance, the device ID 111 may be registered in the computing system 120 by the establishment. In some examples, the computing system 120 may use the device ID 111 to determine information about the establishment, as described in more detail below.

The account ID 113 may, for instance, include information that directly or indirectly identifies an account for the user 102, such as a social networking account for the user 102. For instance, the account ID 113 may identify an account for the user 102, or may indicate the identity of user 102, which is associated with such an account. Examples of information that may be included in the account ID 113 that serve to indicate the identity of user 102 may, for instance, include data that reflects an identifier for the user 102, characteristics of one or more devices that are associated with user 102, or both. The account ID 113 may include a device identifier or other information that identifies a smartphone or other computing device carried by user 102 which the computing system 120 may use to determine account information for the user 102. In some examples, the account ID 113 may include a name or an email address for the user 102.

In some implementations, the computing system 120 may receive an image of the user 102 instead of or in addition to the account ID 113. For instance, the computing system 120 may receive the device ID 111 of the client device 106 and the image 112. The computing system 120 analyzes the image 112 to determine an identifier for the user 102. The computing system 120 may perform facial recognition on the image 112, using any appropriate facial recognition method, to determine the identifier for the user 102. For example, the computing system 120 may include a database of user images or user features that indicate account information for a corresponding user. The computing system 120 may use data from the database to determine whether the database includes a match for the image of the user 102. When the database includes a match for the image of the user 102, the computing system 120 uses the corresponding account information instead of the account ID 113.

In some examples, the client device 106 may transmit the device ID 111, the image 112, and the account ID 113 to the computing system 120 in response to receiving user input data. For instance, the client device 106 may determine that such user input indicates a request for an item recommendation based on one or more items that appear in the image 112. In these examples, the client device 106 may, through execution of an application installed on the client device 106, display one or more user interface screens (not shown) between stages A and B through which the client device 106 receives user input indicating such a request from one or more users of the client device 106, such as user 102. The request may be for product information for the soda can 103, a recommendation of a probability that the user 102 will purchase the soda can 103, a probability that the user 102 will purchase an alternative item, e.g., similar or complementary to the soda can 103, or a combination of two or more of these.

Upon receiving the device ID 111, the image 112, and the account ID 113 from the client device 106, the computing system 120 may, in stage C, use the received data to perform one or more operations through which the computing system 120 identifies one or more items depicted in the image 112. The computing system 120 may determine a recommendation for one or more other items on the based on the one or more items depicted in the image 112. The computing system 120 may generate presentation instructions 130 that indicate the recommendation. The computing system 120 may perform such operations using a catalog selection module 121, an item identification module 122, an account identification module 123, an item recommendation engine 127, a presentation instruction generator 128, or a combination of two or more of these.

The computing system 120 may use the catalog selection module 121 to identify one or more items that are associated with the client device 106. For example, the catalog selection module 121 may be configured to receive input data, e.g., the device ID 111, that identifies the client device 106. The catalog selection module 121 may use the device ID 111 as a key to a database to obtain item information indicating one or more items that are associated with the client device 106. The catalog selection module 121 may generate output indicating the obtained item information. In the example of FIG. 1, the catalog selection module 121, in stage C, receives and subsequently uses the device ID 111 to obtain item information for each of one or more items that are associated with the client device 106. The computing system 120 may, for example, maintain or otherwise have access to one or more databases, e.g., product catalog databases, that each store item information associated with a particular client device from a group of multiple, different client devices. The catalog selection module 121 uses the device ID 111 to select one of the databases to obtain item information for the client device 106.

In some implementations, a database for one of the multiple, different client devices may include item information for one or more catalogs or lists of items that are eligible for retrieval at the respective establishment within which the client device 106 is physically located. In some examples, the client device 106 may be physically located outside the respective establishment, e.g., may be on a sidewalk in front of the respective establishment. The item information that is stored in association with a given client device, and a respective establishment, may include one or more catalogs of products or goods that are available for purchase at the establishment, one or more catalogs of products that are manufactured or distributed by the company that manages the establishment, an up-to-date inventory of items that are currently in stock at the establishment, a list of items that the establishment is prioritizing, e.g., that are on sale, or a combination of two or more of these. For instance, the database for the client device 106 may include item information for products, such as the soda can 103, sold by a particular grocery store. The item information may include information for any appropriate type of item. In some implementations, item information that is stored in association with each client device may include information regarding item pricing, features, specifications, ingredients, availability, ordering options, warnings, or a combination of two or more of these. For example, a database for the client device 106 may include a price for the soda can 103, ingredients for the soda in the soda can 103, and other information about the soda can 103 or the manufacturer of the soda can 103.

The catalog selection module 121 may retrieve an identifier for the database that includes item information for the client device 106. In some examples, the catalog selection module 121 may retrieve an identifier for the database that includes item information for the client device 106.

The item identification module 122 may receive the obtained item information, e.g., the product catalog, for the client device 106 from the catalog selection module 121. The item identification module 122 may receive data from the database that includes item information for the client device 106. In some examples, the item identification module 122 may receive the identifier for the database that includes item information for the client device 106.

The item identification module 122, as described in further detail below, may receive input from the account identification module 123. The item identification module 122 uses the data received from the catalog selection module 121, the account identification module 123, or both, to perform item identification analysis on the image 112. For instance, the item identification module 122 uses the item information to perform item recognition for the image 112 to detect items depicted in the image 112.

The item identification module 122 may use image features to determine whether an item depicted in the image 112 is identified in the obtained item information. For example, the item identification module 122 may compare features of items depicted in the image 112 with image features for items in the product catalog associated with the client device 106. In some examples, the item identification module 122 may use text included on the item to determine whether the item depicted in the image 112 is identified in the obtained item information. For instance, the item identification module 122 may use a label on the item during an object recognition process to determine whether the item is identified in the obtained item information.

The item identification module 122 determines, using the comparison, whether an item depicted in the image 112 is likely identified in the obtained item information. When the item identification module 122 determines that an item depicted in the image 112 is likely identified in the obtained item information, the item identification module 122 determines item information specific to the item. For instance, the item identification module 122 determines that a database likely includes product information for the item depicted in the image 112.

In some examples, the item identification module 122 may determine that an item depicted in the image 112 is not likely identified in the obtained item information. For instance, the item identification module 122 may determine that the database does not likely include product information for the item.

The item identification module 122 may analyze multiple different objects in the image 112. The item identification module 122 may determine that a first object depicted in the image 112 is likely a user and stop analyzing the first object. The item identification module 122 may determine that a second object depicted in the image 112 is likely not identified in the item information, e.g., the second object is a purse that the establishment does not sell. The item identification module 122 may determine that a third object depicted in the image 112 is likely identified in the item information, e.g., that the soda can 103 is for a type of soda sold by the establishment. The item identification module 122 may use object recognition to determine any appropriate type of item depicted in the image 112.

The computing system 120 may use the account identification module 123 to determine account data for one or more user accounts for one or more users of the client device 106, such as the user 102. The account identification module 123 may be configured to receive input data that identifies one or more users or user accounts that are associated with the image 112 as captured by the client device 106. The account identification module 123 obtains account data of user accounts identified in the input data or user accounts for one or more users identified in the input data, and generates an output indicating the obtained account data. In the example of FIG. 1, the account identification module 123, in stage C, receives and subsequently uses the account ID 113 to obtain account data for a user account that for the user 102, e.g., and associated with the image 112. The computing system 120 may, for example, maintain or have access to one or more databases storing account data in association with each of multiple, different known user accounts, and reference such information to obtain account data for each user account identified in information received over one or more networks, such as network 110.

Account data that is stored in association with each user account may include information indicating one or more characteristics of the user account. For example, account data that is stored in association with a given user account, such as a social networking account, may include information indicating posts, social connections, user activity, the physical locations of one or more client devices on which the social networking service is being accessed through use of the given user account, user account check-ins, user likes and dislikes, profile, metadata about one or more of the aforementioned pieces of information, or a combination of two or more of these.

The account identification module 123 may provide the account data as input to the item identification module 122 of the computing system 120. For example, the item identification module 122 may receive the image 112, e.g., from the computing system 120, and the obtained account data, e.g., from the account identification module 123, the obtained item information, e.g., from the catalog selection module 121, or both. The item identification module may use the item information, the account data, or both to perform item recognition analysis on the image 112, and to generate an output indicating one or more items determined as likely appearing in the image 112.

In the example of FIG. 1, the item identification module 122, in stage C, receives the item information obtained by the catalog selection module 121, the account data obtained by the account identification module 123, or both, and the image 112. The item identification module 122 uses the received item information, the received account data, or both, to perform item recognition analysis on the image 112 to identify one or more items that likely appear in the image 112. The item identification module 122 may, for instance, determine a probability that that each of the items in the database for the client device 106 are the item depicted in the image 112. In some examples, the item identification module 122 may compare the probabilities for each of the items with a threshold probability. Upon determining that a probability for a particular item satisfies the threshold probability, e.g., is greater than or equal to the threshold probability, the item identification module 122 may, for instance, determine that the particular item is likely depicted in the image 112. The item identification module 122 may select the particular item with a probability greater than other probabilities for other items identified in the database for the client device 106. For instance, the item identification module 122 may select the particular item with the greatest probability and compare the greatest probability with the threshold probability.

In some implementations, the computing system 120 maintains or otherwise has access to one or more databases storing data for each item referenced in the item information. The computing system 120 may reference such data when analyzing the image 112 to determine whether an item is depicted in the image 112. Such data may, for example, include one or more images of the item with which the item data is associated, template data that may be used for recognizing the item with which the item data is associated, item fingerprint data that indicate particular characteristics of the item, or a combination of two or more of these.

In some examples, the item identification module 122 may use the item information received from the catalog selection module 121 to obtain data for each item that is associated with the establishment in which the client device 106 is physically located. The item identification module 122 may compare the image 112 or features of the image 112 with the obtained data to determine one or more items likely appearing in the image 112. That is, instead of comparing the image 112 with all item data stored in one or more of the databases that are maintained by or otherwise accessible to the computing system 120, the item identification module 122 may only compare the image 112 with data for items that are available to patrons of the establishment within which the client device 106 is physically located. For instance, the item identification module 122 prunes the search space to only the items for the client device 106. In this way, the computing system 120 may identify one or more items likely appearing in the image 112 in an efficient, e.g., by reducing the computer resources necessary for analysis of the image 112.

In some implementations, the item identification module 122 may use the account data received from the account identification module 123 to determine one or more items likely appearing in the image 112. For instance, the item identification module 122 may use the account data to determine items typically purchased by the user 102. The account data may indicate the items typically purchased by the user 102. In some examples, the item identification module 122 may use the account data to determine information about the user 102. The item identification module 122 may use the determined information about the user 102 to determine items likely appearing in the image 112. For instance, the item identification module 122 may determine that the user 102 typically purchases items of one or more particular types, typically purchases items from a particular establishment, has used particular items in the past, or a combination of two or more of these. The item identification module 122 may use data for the particular types, data for the particular establishment, data for the particular items, or a combination of two or more of these, to determine one or more items likely appearing in the image 112.

The item identification module 122 may prune the search space using the account data, the determined information about the user 102, or both. For instance, the item identification module 122 may compare data for the image 112 or data for items depicted in the image 112 only with: data for items of the particular types; data for items from the particular establishment, whether or not the particular establishment is the same establishment as the establishment in which the client device 106 is located; data for the particular items the user has used in the past; or a combination of two or more of these.

In some implementations, the item identification module 122 may prune the search space using two or more of the account data, the determined information about the user 102, or the obtained item information for the client device 106. For instance, the item identification module 122 may determine item information for the client device 106. The item identification module 122 may determine the item information by receiving the item information from the catalog selection module 121. The item identification module 122 may determine the item information by receiving an identifier for a database that includes the item information from the catalog selection module 121.

The item identification module 122 may then prune the item information for the client device 106 using the account data, the determined information about the user 102, or both. For instance, the item identification module 122 compares data for an item in the image 112 with data only for the items identified by the account information, items identified by the determined information about the user 102, or both. The item identification module 122 determines, using the comparison, a probability that the item depicted in the image 112 is an item from the pruned item information for the client device 106. The item identification module 122 may compare the probability with a threshold probability to determine whether the probability satisfies the threshold probability. When the probability satisfies the threshold probability, e.g., the probability is greater than, equal to, or both, the threshold probability, the item identification module 122 may determine product information for the item from the pruned item information for which the probability applies.

When all probabilities that the item depicted in the image 112 is one of the items in the pruned item information do not satisfy the threshold probability, the item identification module 122 may compare data for the item to other data for items in the item information for the client device 106 that were not included in the pruned item information. For instance, the item identification module 122 may determine that there is no match for the item in the pruned item information and search the rest of the item information that was pruned from the item information to determine whether the item information includes a match for the item.

In some implementations, the item identification module 122 may leverage one or more image recognition or signal processing techniques to identify one or more items likely shown in the image 112. In the example of FIG. 1, the item identification module 122 may determine that a twelve ounce can of “Lime Soda” is likely depicted in the image 112, determine product information, e.g., item identification information, for the soda can 103. The item identification module 122 generates an output that includes the product information.

The item recommendation engine 127 may receive data from one or more of the catalog selection module 121, the item identification module 122, or the account identification module 123. For instance, the item recommendation engine 127 may use the obtained item information for the client device 106 to determine another item, e.g., a recommended item, that is similar or complementary to the identified item.

The item recommendation engine 127 may use data from the obtained item information to determine another item that is not depicted in the image 112, e.g., a recommended item. The item recommendation engine 127 may compare attributes of the item depicted in the image 112 with attributes of other items referenced in the item information to determine the other item. For example, the item recommendation engine 127 may determine that the item depicted in the image 112 is the soda can 103 for “lime soda.” The item recommendation engine 127 may determine one or more attributes for the soda can 103, such as a type of product for the soda can 103, e.g., soda, food, or tool; a manufacturer of the soda can 103; a type of soda, e.g., lime; whether or not the soda is caffeinated; a flavor for the soda can 103; an amount of sodium in the soda; another appropriate attribute; or a combination of two or more of these. The item recommendation engine 127 may use an attribute for the type of product that may indicate a value for whether the item is a food item, a beverage, or a tool, e.g., a drill. The item recommendation engine 127 may use an attribute that is specific to the product that has a value that identifies the flavor or sodium level for the item or whether the item is caffeinated.

The item recommendation engine 127 uses the determined attributes for the identified item to select the other item such that the other item has the same value, similar values, or a combination of both, for the determined attributes as the item depicted in the image 112. For instance, when the soda can 103 for lime soda has thirty milligrams of sodium, the item recommendation engine 127 may determine the other item as cranberry-lime blast soda which has twenty-nine milligrams of sodium, also is not caffeinated, and includes at least some lime flavor.

In some implementations, the item recommendation engine 127 may determine a complementary item using the determined attributes. When the identified item is the soda can 103, the item recommendation engine 127 may determine chips, pretzels, or another food item that complements the soda. The item recommendation engine 127 may use the account data identified by the account identification module 123 to determine a complementary item. For example, the item recommendation engine 127 may determine that the user 102 has purchased a particular type of cracker, using historical data included in the account data or identified by the account data, and recommend the particular type of cracker as a complementary recommended item for the soda.

The item recommendation engine 127 may use information about the user 102 included in the account data to determine the recommended item. For instance, the item recommendation engine 127 may determine whether the user 102 has any allergies. When the item recommendation engine 127 determines that the user 102 has one or more allergies, the item recommendation engine 127 uses allergy information about the user 102 to determine a recommended item to which the user 102 will not be allergic. The item recommendation engine 127 may use data that indicates item preferences of the user 102. For example, the item recommendation engine 127 may determine whether the user 102 is vegetarian, vegan, prefers environmentally friendly items, or a combination of two or more of these item preferences. The item recommendation engine 127 may use some or all of the item preferences to determine a recommended item for the user 102.

In some implementations, the item recommendation engine 127 may determine whether the user 102 has a roommate, a family, or both. The item recommendation engine 127 may use data that indicates whether the user 102 has a roommate, a family, or both, when determining a recommended item. For example, when the item recommendation engine 127 determines that the user 102 has one or more children, e.g., using the account data, the item recommendation engine 127 may determine a recommended item that is kid friendly, e.g., for an age of the child or the children.

The item recommendation engine 127 may use other data that indicates items that complement the identified item. For instance, the item recommendation engine 127 may use historical data for the establishment or another entity that indicates that a particular item complements the identified item and determine to provide a recommendation for the particular item. In some examples, the item recommendation engine 127 may use data that indicates that the particular item and the identified item are frequently purchased together, e.g., more than a threshold amount, and determine to provide a recommendation for the particular item. The item recommendation engine 127 may use historical data that indicates that people who purchased the identified item, e.g., lime soda, purchase a recommended item, e.g., lime carbonated water or grapefruit soda, at least a threshold amount. The item recommendation engine 127 may use a correlation between the two items, e.g., that indicates that people who purchase one of the two items purchase the other a threshold amount, when determining the recommended item, a probability that the user 102 will purchase the recommended item, or both.

The item recommendation engine 127 may determine a probability that the user 102 will purchase the other item. The item recommendation engine 127 may use attributes of the other item and the account data to determine the probability. The item recommendation engine 127 may compare the probability with a threshold probability to determine whether the probability satisfies the threshold probability, e.g., is greater than, equal to, or greater than or equal to the threshold probability. When the item recommendation engine 127 determines that the probability satisfies the threshold probability, the item recommendation engine 127 may provide product information for the other item, potentially with the product information for the item depicted in the image 112, to the presentation instruction generator 128. When the item recommendation engine 127 determines that the probability does not satisfy the threshold probability, the item recommendation engine 127 may determine another alternative item, e.g., a second recommended item, that is not depicted in the image 112 and a corresponding probability. If the item recommendation engine 127 determines that there are no other alternative items that are not depicted in the image 112 with attributes similar to those of the item depicted in the image 112, or that none of the probabilities for the other alternative items satisfy the threshold probability, the item recommendation engine 127 may perform no further action or may provide the presentation instruction generator 128 with data indicating that no recommendation will be made. In some examples, when the item recommendation engine 127 determines that there are no other alternative items that are not depicted in the image 112 with attributes similar to those of the item depicted in the image 112, or that none of the probabilities for the other alternative items satisfy the threshold probability, the computing system 120 may determine to generate instructions for presentation of a user interface with a generic message. The generic message may include information about the item depicted in the image, the establishment, or other appropriate information.

The presentation instruction generator 128 uses received data to generate presentation instructions 130. The presentation instructions 130 may be Hypertext Markup Language (HTML) instructions, user interface instructions, or another appropriate type of instructions that cause the client device 106 to present information. For example, when the presentation instruction generator 128 receives data for the item depicted in the image 112 and the other item not depicted in the image 112, e.g., a recommended item, the presentation instruction generator 128 may generate instructions for presentation of a user interface that includes information about the item and the other item.

The presentation instruction generator 128 may determine, using product information and the account data, attributes specific to the account data, the user 102, or both. For instance, the presentation instruction generator 128 may determine that the instructions should include information about sodium but not about a number of calories or whether or not the soda is caffeinated. The presentation instruction generator 128 may determine for which attributes to include values in the presentation instructions 130 based on preferences or inferred preferences of the user 102. The presentation instruction generator 128 may infer the preferences, using the account data, or determine explicitly defined preferences, e.g., settings. In some examples, when the presentation instruction generator 128 infers preferences, the presentation instruction generator 128 may determine, for a type of the item depicted in the image 112, the attributes the user 102 typically reviews, e.g., when making a purchasing decision. The presentation instruction generator 128 may use the inferred preferences to generate the presentation instructions 130 only for the attributes of the inferred preferences that are relevant to the user 102 to make the generation of the presentation instructions 130 more efficient, e.g., to reduce the computer resources necessary to generate the presentation instructions 130, such as memory, processor cycles, or both.

The computing system 120 provides the presentation instructions 130 to the client device 106 to cause the client device 106 to generate a user interface. For instance, when the client device 106 receives the presentation instructions 130, the client device 106 generates a second user interface 108e. The second user interface 108e may include information about the item depicted in the image 112, the other item, e.g., the recommended item, or both. The second user interface 108e may include attribute information for one or both items. For example, the second user interface 108e may include a first sodium value of thirty milligrams for the item depicted in the image 112, a second sodium value of twenty-nine milligrams for the recommended item, or both.

In some examples, the second user interface 108e may include instructions that indicate where to find the recommended item that was not depicted in the image 112. For instance, the second user interface 108e may include an aisle number that indicates where the recommended item may be physically located in the establishment in which the client device 106 is physically located.

The second user interface 108e may include any appropriate attribute information about the item, the recommended item, or both. For example, the second user interface 108e may include a price, a size, a quantity, e.g., of items in a package, or a combination of two or more of these. The computing system 120 may determine the attributes to present in the second user interface 108e using the account information for the user.

In some implementations, the item identification module 122 may provide product data for the item depicted in the image 112 to the presentation instruction generator 128. For instance, the presentation instruction generator 128 may generate the presentation instructions 130 that include only information for the item depicted in the image 112. In these implementations, the presentation instruction generator 128 uses the account data, from the account identification module 123, to determine attributes relevant to the user 102. The presentation instruction generator 128 determines a non-empty subset of attributes for the item using the account data such that the subset does not include all of the attributes for the item. The presentation instruction generator 128 generates the presentation instructions 130 for the non-empty subset of attributes for the item depicted in the image 112.

In some implementations, when the image 112 depicts multiple items that are not a person, the item recommendation engine 127 may use attribute data for two or more of the depicted items to determine a recommended item. For example, the item recommendation engine 127 may determine that the image depicts the soda can 103 and a bottle of carbonated water. The item recommendation engine 127 uses first attributes for the first item, e.g., the soda can 103, and second attributes for the second item, e.g., the bottle of carbonated water, to determine recommended attributes, a recommended item, or both. The item recommendation engine 127 may determine recommended attribute values of carbonated, caffeine free, low sugar, and beverage, potentially in addition to one or more additional attributes. The item recommendation engine 127 uses the recommended attributes to determine a recommended item, such as flavored carbonated water. For instance, the item recommendation engine 127 may determine lime carbonated water as the recommended item.

The item recommendation engine 127 may determine a probability that the user will purchase the item depicted in the image 112. For example, the item recommendation engine 127 may use the account data to determine the probability that the user 102 will purchase the item determined to be depicted in the image 112.

The item recommendation engine 127 may compare a first probability for the item depicted in the image 112 with a second probability for the other item not depicted in the image 112. The item recommendation engine 127 may determine whether the second probability satisfies the first probability. For instance, the item recommendation engine 127 may determine whether the second probability is greater than the first probability. In some examples, the item recommendation engine 127 may determine whether the second probability is greater than or equal to the first probability.

When the second probability satisfies the first probability, the item recommendation engine 127 may provide the presentation instruction generator 128 with product information for both the item and the other item. When the second probability does not satisfy the first probability, the item recommendation engine 127 may provide the presentation instruction generator 128 with product information only for the item depicted in the image 112 and might not provide the presentation instruction generator 128 with product information for the other item not depicted in the image 112.

In some implementations, the computing system 120 may determine to identify a recommend item when a probability for the item depicted in the image 112 does not satisfy a threshold probability. For instance, the computing system 120 may determine a probability that the user 102 will purchase the item depicted in the image 112. The computing system 120 compares the probability with a threshold probability to determine whether the probability satisfies the threshold probability, e.g., whether the probability is greater than, or equal to or greater than, the threshold probability. When the computing system 120 determines that the probability does not satisfy the threshold probability, the computing system 120 may determine to identify a recommended item. When the computing system 120 determines that the probability satisfies the threshold probability, the computing system 120 may determine not to identify a recommended item.

In some implementations, the computing system 120 may use social networking account activity when determining a probability, a recommended item, or both. For example, the item recommendation engine 127 may use data that indicates a physical location at which the client device 106 is located, data that indicates particular people who are likely with the user 102, data that indicates preferences of one or more of the particular people who are likely with the user 102, or a combination of two or more of these when determining a recommended item. The computing system 120 may use check in information, data that indicates a reservation for the user 102, or other appropriate information to determine the physical location at which a device of the user 102 is physically located. For instance, the client device 106 may be a mobile device of the user 102 that includes an application that captures the image 112. In some examples, the device of the user 102 may be a mobile device separate from the client device 106.

The computing system 120 may use social networking data, or data in a calendar appointment, to determine the particular people who are likely with the user 102. The calendar appointment may list the names of the particular people. In some examples, when a particular person is connected with the user 102 on a social network, the computing system 120 may determine that the particular person checked in to the same physical location, e.g., establishment, as the user 102 and that the particular person is likely with the user 102.

The computing system 120 may determine preferences of the user 102, preferences of one or more of the particular people, or both. The preferences of the particular people may indicate items previously purchased by a respective person. The computing system 120 may use the determined preferences when determining a probability, for the item or a recommended item, when determining a recommended item, or both. For instance, the computing system 120 may determine that the user 102 has first preferences for items with first attributes when with a first group of particular people and second preferences for items with second attributes, different than the first attributes, when with a second group of particular people. The first attributes may indicate that the user 102 drinks carbonated water when with persons from the first group. The second attributes may indicate that the user 102 drinks a particular brand of soda when with persons from the second group.

In some examples, the computing system 120, e.g., the item recommendation engine 127, may determine a recommended item as a complementary item using data for one or more of the particular people. For example, the computing system 120 may determine a favorite brand or type of chips for a particular person from the particular people, e.g., a friend of the user 102 who is with the user. The computing system 120 may determine a recommendation for a particular type of chips using the particular person's favorite brand or type of chips, e.g., such that the particular type is the favorite type or the particular type is made by the favorite brand.

In some implementations, the computing system 120 may use data for particular people who are not currently with the user 102. For instance, the computing system 120 may use social networking data that indicates that the user 102 and the particular people will be at an event together later that day. The computing system 120 may use data for one or more of the particular people to determine a recommended item.

The computing system 120 may determine that the user 102 has first preferences when at a first establishment and second preferences, different than the first preferences, when at a second establishment. For example, the first preferences may indicate that the user 102 typically purchases a particular type of item with first attributes when at the first establishment. The second preferences may indicate that the user 102 typically purchases the particular type of item, e.g., a beverage, with second attributes, different than the first attributes, when at the second establishment.

The computing system 120 is an example of a system implemented as computer programs on one or more computers in one or more locations, in which the systems, components, and techniques described in this document are implemented. The computing system 120 may use a single server computer or multiple server computers operating in conjunction with one another, including, for example, a set of remote computers deployed as a cloud computing service.

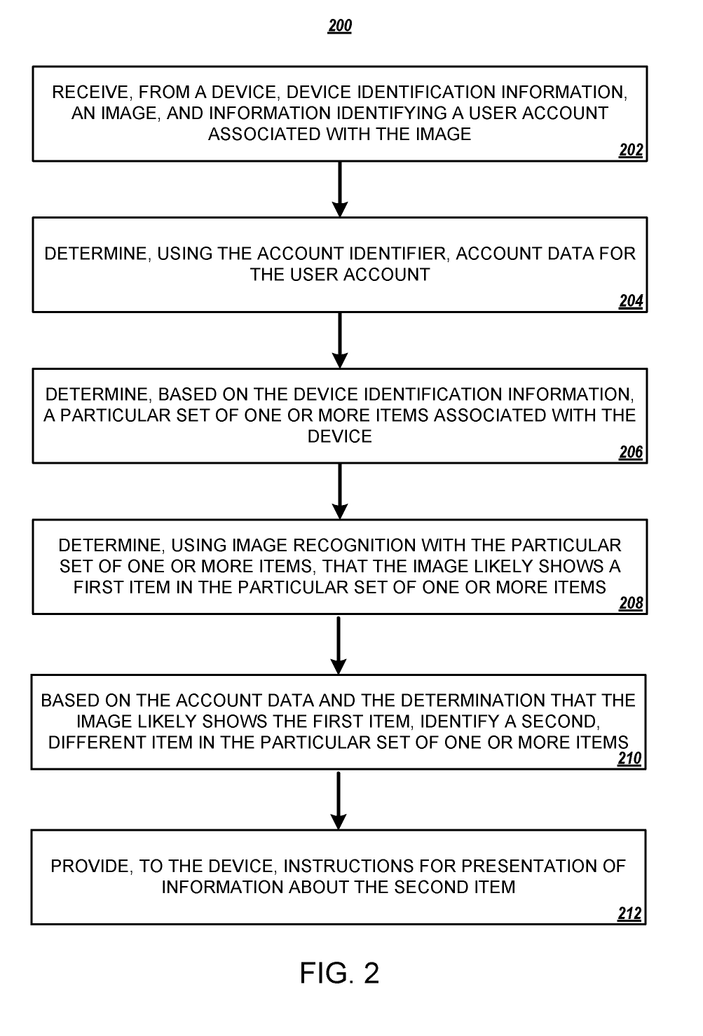

FIG. 2 is a flowchart of an example process 200 for determining an item recommendation. The following describes the process 200 as being performed by components of systems that are described with reference to FIG. 1. However, process 200 may be performed by other systems or system configurations in addition to or instead of components of the system described with reference to FIG. 1. Briefly, the process 200 may include receiving, from a device, device identification information, an image, and information identifying a user account associated with the image (202), determining, using the account identifier, account data for the user account (204), determining, based on the device identification information, a particular set of one or more items associated with the device (206), determining, using image recognition with the particular set of one or more items, that the image likely shows a first item in the particular set of one or more items (208), based on the account data and the determination that the image likely shows the first item, identifying a second, different item in the particular set of one or more items (210), and providing, to the device, instructions for presentation of information about the second item (212).

The process 200 may include receiving, from a device, (i) device identification information for the device, (ii) an image that was captured by the device, and (iii) an account identifier identifying a user account that is associated with the image (202). A computing system may receive data for the device identification information, the image, and the account identifier from the device. In some examples, the device may receive the data for the device identification information, the image, and the account identifier from a memory of the device.

The process 200 may include determining, using the account identifier, account data for the user account (204). The user account may be for a person depicted in the image who is holding an item depicted in the image. In some examples, the user account may be for a person who placed an item in a field of view of a camera that captured the image.

The process 200 may include determining, based on the device identification information, a particular set of one or more items associated with the device (206). A computing system may determine a product catalog for items available at an establishment in which the device is physically located or with which the device is associated.

The process 200 may include determining, using image recognition with the particular set of one or more items, that the image likely shows a first item in the particular set of one or more items (208). A computing system may determine, for multiple items in the product catalog, a probability that an item depicted in the image is likely the respective item in the product catalog. The computing system may compare the probabilities for the multiple items with the other determined probabilities. The computing system may select a highest probability and determine information about a respective item from the product catalog.

The process 200 may include using the account data and the determination that the image likely shows the first item in the particular set of one or more items, identifying, from among the particular set of one or more items, a second item in the particular set of one or more items that is different from the first item and includes an attribute value that is the same as the first item (210). A computing system may determine a probability that a particular item is depicted in the image. The computing system may compare the probability with a threshold probability. The computing system may determine that the image likely shows the particular item when the probability for the particular item satisfies the threshold probability.

The process 200 may include providing, to the device, instructions for presentation of information about the second item (212). For example, a computing system may provide the instructions to the device to cause the device to present a user interface with information about the second item, the first item, or both, on a display. In some examples, the device may present the information audibly, e.g., using text to speech functionality.

In some implementations, the process 200 may include providing, to a second device, instructions of information about the second item. For example, the computing system may receive data that identifies a second device to which the computing system should provide the instructions. The second device may be the device from which the computing system receives the device identification information, the image, and the account identifier. In some examples, the second device is a different device than the device from which the computing system receives the device identification information. For instance, the device from which the computing system receives the device identification information may be a kiosk located in a physical store and the second device may be a user device.

The computing system may provide the instructions to the second device, that is a different device from which the computing system received the device identification information, to increase privacy. For instance, the information about the second item, information about the first item, the second item, or a combination of two or more of these, may be specific to the user, may contain information the user does not want others to easily identify, or both. The computing system may provide the instructions to the second device to increase a likelihood that another person will not see any of the information.

In some examples, the device, e.g., the kiosk, may include a user interface with an option that receives user input indicating a destination address for the instructions. The option may accept user input indicating an email address, a social media account, a device identifier, e.g., telephone number, or other appropriate identification information for the destination address. The computing system may analyze the received data, e.g., received in step 202 or at another time, to determine the destination to which the computing system should send the instructions.

The order of steps in the process 200 described above is illustrative only, and the steps for determining the item recommendation can be performed in different orders. For example, the process 200 may include the determination of the account data for the user account after the determination of the particular set of items associated with the device.

In some implementations, the process 200 can include additional steps, fewer steps, or some of the steps can be divided into multiple steps. For example, the process 200 may include a portion of step 202, e.g., without receipt of the data identifying the user account, and steps 206 through 212 without including step 204.

In some implementations, the client device 106 may use facial recognition techniques to allow the user 102 to purchase an item. For example, when the client device 106 presents the user interface 108e, the user interface 108e may include an option that accepts user input indicating purchase of the identified item, the recommended item, or both. In response to receipt of the user input, the client device 106 may initiate a purchase transaction.

For instance, the client device 106 may generate a prompt requesting input that identifies a payment type. In some examples, the client device 106 may include a facial recognition option as a payment type. In response to receipt of input indicating selection of the facial recognition option, the client device 106 captures an image of the user 102. In some examples, the client device 106 may use the image 112 that depicts the user 102.

The client device 106 uses the image of the user 102 to determine account information for the user and corresponding payment preferences. The client device 106 uses the payment preferences to complete a transaction for the identified item, the recommended item, or both. For instance, the client device 106 may receive the input that indicates the facial recognition option as a payment type. The computing system 120 receives, from the client device 106, a request for payment preferences identified in the account data for the user 102. The computing system 120 may determine, using the account data previously determined for the user 102, payment preferences. The computing system 120 may perform facial recognition on the image 112 or another image of the user 102 to determine payment preferences for the user. In some examples, the computing system 120 or the client device 106 may use the payment preferences to complete a transaction for the identified item, the recommended item, or both. The client device 106 may present information about the payment preferences on a display, e.g., in another user interface.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a computing system.

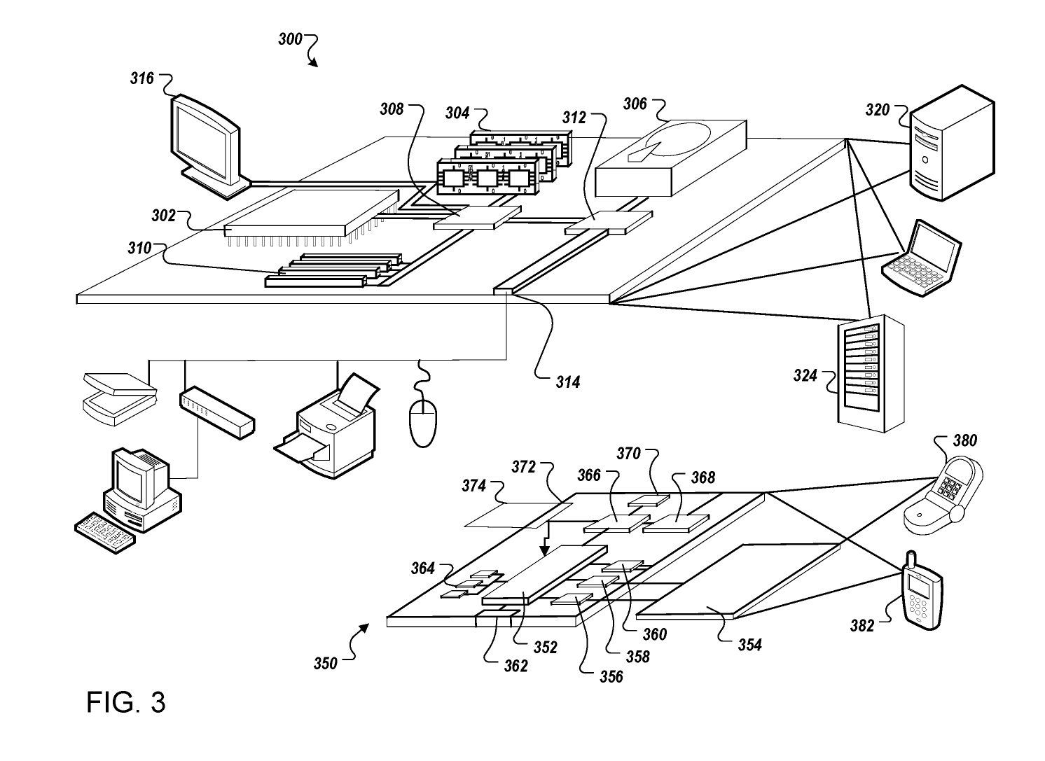

FIG. 3 shows an example of a computing device 300 and a mobile computing device 350 that can be used to implement the techniques described herein. The computing device 300 is intended to represent various forms of digital computers, such as laptops, desktops, workstations, personal digital assistants, servers, blade servers, mainframes, and other appropriate computers. The mobile computing device 350 is intended to represent various forms of mobile devices, such as personal digital assistants, cellular telephones, smart-phones, and other similar computing devices. The components shown here, their connections and relationships, and their functions, are meant to be examples only, and are not meant to be limiting.

The computing device 300 includes a processor 302, a memory 304, a storage device 306, a high-speed interface 308 connecting to the memory 304 and multiple high-speed expansion ports 310, and a low-speed interface 312 connecting to a low-speed expansion port 314 and the storage device 306. Each of the processor 302, the memory 304, the storage device 306, the high-speed interface 308, the high-speed expansion ports 310, and the low-speed interface 312, are interconnected using various busses, and may be mounted on a common motherboard or in other manners as appropriate.

The processor 302 can process instructions for execution within the computing device 300, including instructions stored in the memory 304 or on the storage device 306 to display graphical information for a graphical user interface (GUI) on an external input/output device, such as a display 316 coupled to the high-speed interface 308. In other implementations, multiple processors and/or multiple buses may be used, as appropriate, along with multiple memories and types of memory. Also, multiple computing devices may be connected, with each device providing portions of the necessary operations, e.g., as a server bank, a group of blade servers, or a multi-processor system.

The memory 304 stores information within the computing device 300. In some implementations, the memory 304 is a volatile memory unit or units. In some implementations, the memory 304 is a non-volatile memory unit or units. The memory 304 may also be another form of computer-readable medium, such as a magnetic or optical disk.

The storage device 306 is capable of providing mass storage for the computing device 300. In some implementations, the storage device 306 may be or contain a computer-readable medium, such as a floppy disk device, a hard disk device, an optical disk device, or a tape device, a flash memory or other similar solid state memory device, or an array of devices, including devices in a storage area network or other configurations. Instructions can be stored in an information carrier. The instructions, when executed by one or more processing devices, for example, processor 302, perform one or more methods, such as those described above. The instructions can also be stored by one or more storage devices such as computer- or machine-readable mediums, for example, the memory 304, the storage device 306, or memory on the processor 302.

The high-speed interface 308 manages bandwidth-intensive operations for the computing device 300, while the low-speed interface 312 manages lower bandwidth-intensive operations. Such allocation of functions is an example only. In some implementations, the high-speed interface 308 is coupled to the memory 304, the display 316, e.g., through a graphics processor or accelerator, and to the high-speed expansion ports 310, which may accept various expansion cards (not shown).

In the implementation, the low-speed interface 312 is coupled to the storage device 306 and the low-speed expansion port 314. The low-speed expansion port 314, which may include various communication ports, e.g., USB, Bluetooth, Ethernet, wireless Ethernet, may be coupled to one or more input/output devices, such as a keyboard, a pointing device, a scanner, or a networking device such as a switch or router, e.g., through a network adapter.

The computing device 300 may be implemented in a number of different forms, as shown in the figure. For example, it may be implemented as a standard server 320, or multiple times in a group of such servers. In addition, it may be implemented in a personal computer such as a laptop computer 322. It may also be implemented as part of a rack server system 324.

Alternatively, components from the computing device 300 may be combined with other components in a mobile device (not shown), such as a mobile computing device 350. Each of such devices may contain one or more of the computing device 300 and the mobile computing device 350, and an entire system may be made up of multiple computing devices communicating with each other.

The mobile computing device 350 includes a processor 352, a memory 364, an input/output device such as a display 354, a communication interface 366, and a transceiver 368, among other components. The mobile computing device 350 may also be provided with a storage device, such as a micro-drive or other device, to provide additional storage. Each of the processor 352, the memory 364, the display 354, the communication interface 366, and the transceiver 368, are interconnected using various buses, and several of the components may be mounted on a common motherboard or in other manners as appropriate.

The processor 352 can execute instructions within the mobile computing device 350, including instructions stored in the memory 364. The processor 352 may be implemented as a chipset of chips that include separate and multiple analog and digital processors. The processor 352 may provide, for example, for coordination of the other components of the mobile computing device 350, such as control of user interfaces, applications run by the mobile computing device 350, and wireless communication by the mobile computing device 350.

The processor 352 may communicate with a user through a control interface 358 and a display interface 356 coupled to the display 354. The display 354 may be, for example, a TFT (Thin-Film-Transistor Liquid Crystal Display) display or an OLED (Organic Light Emitting Diode) display, or other appropriate display technology. The display interface 356 may comprise appropriate circuitry for driving the display 354 to present graphical and other information to a user. The control interface 358 may receive commands from a user and convert them for submission to the processor 352.

In addition, an external interface 362 may provide communication with the processor 352, so as to enable near area communication of the mobile computing device 350 with other devices. The external interface 362 may provide, for example, for wired communication in some implementations, or for wireless communication in other implementations, and multiple interfaces may also be used.

The memory 364 stores information within the mobile computing device 350. The memory 364 can be implemented as one or more of a computer-readable medium or media, a volatile memory unit or units, or a non-volatile memory unit or units. An expansion memory 374 may also be provided and connected to the mobile computing device 350 through an expansion interface 372, which may include, for example, a SIMM (Single In Line Memory Module) card interface. The expansion memory 374 may provide extra storage space for the mobile computing device 350, or may also store applications or other information for the mobile computing device 350.

Specifically, the expansion memory 374 may include instructions to carry out or supplement the processes described above, and may include secure information also. Thus, for example, the expansion memory 374 may be provided as a security module for the mobile computing device 350, and may be programmed with instructions that permit secure use of the mobile computing device 350. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, instructions are stored in an information carrier that the instructions, when executed by one or more processing devices, for example, processor 352, perform one or more methods, such as those described above. The instructions can also be stored by one or more storage devices, such as one or more computer- or machine-readable mediums, for example, the memory 364, the expansion memory 374, or memory on the processor 352. In some implementations, the instructions can be received in a propagated signal, for example, over the transceiver 368 or the external interface 362.

The mobile computing device 350 may communicate wirelessly through the communication interface 366, which may include digital signal processing circuitry where necessary. The communication interface 366 may provide for communications under various modes or protocols, such as GSM voice calls (Global System for Mobile communications), SMS (Short Message Service), EMS (Enhanced Messaging Service), or MIMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others.

Such communication may occur, for example, through the transceiver 368 using a radio-frequency. In addition, short-range communication may occur, such as using a Bluetooth, WiFi, or other such transceiver (not shown). In addition, a GPS (Global Positioning System) receiver module 370 may provide additional navigation- and location-related wireless data to the mobile computing device 350, which may be used as appropriate by applications running on the mobile computing device 350.

The mobile computing device 350 may also communicate audibly using an audio codec 360, which may receive spoken information from a user and convert it to usable digital information. The audio codec 360 may likewise generate audible sound for a user, such as through a speaker, e.g., in a handset of the mobile computing device 350. Such sound may include sound from voice telephone calls, may include recorded sound, e.g., voice messages, music files, etc., and may also include sound generated by applications operating on the mobile computing device 350.

The mobile computing device 350 may be implemented in a number of different forms, as shown in the figure. For example, it may be implemented as a cellular telephone 380. It may also be implemented as part of a smart-phone 382, personal digital assistant, or other similar mobile device.

Embodiments of the subject matter, the functional operations and the processes described in this specification can be implemented in digital electronic circuitry, in tangibly-embodied computer software or firmware, in computer hardware, including the structures disclosed in this specification and their structural equivalents, or in combinations of one or more of them. Embodiments of the subject matter described in this specification can be implemented as one or more computer programs, i.e., one or more modules of computer program instructions encoded on a tangible nonvolatile program carrier for execution by, or to control the operation of, data processing apparatus.

Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them.

The term “data processing apparatus” encompasses all kinds of apparatus, devices, and machines for processing data, including by way of example a programmable processor, a computer, or multiple processors or computers. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a standalone program or as a module, component, subroutine, or other unit suitable for use in a computing environment. A computer program may, but need not, correspond to a file in a file system.

A program can be stored in a portion of a file that holds other programs or data, e.g., one or more scripts stored in a markup language document, in a single file dedicated to the program in question, or in multiple coordinated files, e.g., files that store one or more modules, sub programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Computers suitable for the execution of a computer program include, by way of example, can be based on general or special purpose microprocessors or both, or any other kind of central processing unit. Generally, a central processing unit will receive instructions and data from a read-only memory or a random access memory or both. The essential elements of a computer are a central processing unit for performing or executing instructions and one or more memory devices for storing instructions and data.

Generally, a computer will also include, or be operatively coupled to receive data from or transfer data to, or both, one or more mass storage devices for storing data, e.g., magnetic, magneto optical disks, or optical disks. However, a computer need not have such devices. Moreover, a computer can be embedded in another device, e.g., a mobile telephone, a personal digital assistant (PDA), a mobile audio or video player, a game console, a Global Positioning System (GPS) receiver, or a portable storage device, e.g., a universal serial bus (USB) flash drive, to name just a few.

Computer readable media suitable for storing computer program instructions and data include all forms of nonvolatile memory, media and memory devices, including by way of example semiconductor memory devices, e.g., EPROM, EEPROM, and flash memory devices; magnetic disks, e.g., internal hard disks or removable disks; magneto optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specific implementation details, these should not be construed as limitations on the scope of what may be claimed, but rather as descriptions of features that may be specific to particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

For situations in which the systems discussed here collect personal information about users, or may make use of personal information, the users may be provided with an opportunity to control whether programs or features collect personal information (e.g., information about a user's social network, social actions or activities, profession, a user's preferences, or a user's current location), or to control whether and/or how to receive content from the content server that may be more relevant to the user. In addition, certain data may be anonymized in one or more ways before it is stored or used, so that personally identifiable information is removed. For example, a user's identity may be anonymized so that no personally identifiable information can be determined for the user, or a user's geographic location may be generalized where location information is obtained (such as to a city, ZIP code, or state level), so that a particular location of a user cannot be determined. Thus, the user may have control over how information is collected about him or her and used by a content server.

Particular embodiments of the subject matter have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain implementations, multitasking and parallel processing may be advantageous. Other steps may be provided, or steps may be eliminated, from the described processes. Accordingly, other implementations are within the scope of the following claims.

What is claimed is:

1. A computer-implemented method comprising:
receiving, from a first device, (i) device identification information for the first device, (ii) an image that was captured by the first device, and (iii) an account identifier identifying a user account that is associated with the image;
determining, using the account identifier, account data for the user account;
determining, based on the first device identification information, a particular set of one or more items associated with the first device;
determining, using image recognition with the particular set of one or more items, that the image likely shows a first item in the particular set of one or more items;
using the account data and in response to the determination that the image likely shows the first item in the particular set of one or more items, identifying, from among the particular set of one or more items, a second item in the particular set of one or more items that is different from the first item for which a first attribute value for the first item is the same as a second attribute value for the second item; and
providing, to a second device, instructions for presentation of information about the second item.

2. The computer-implemented method of claim 1, further comprising:
identifying, using the account data for the user account, a subset of the particular set of one or more items, wherein determining, using image recognition with the particular set of one or more items, that the image likely shows the first item in the particular set of one or more items comprises determining, using image recognition with the subset of the particular set of one or more items, that the image likely shows the first item in the subset of the particular set of one or more items.

3. The computer-implemented method of claim 2, wherein identifying, from among the particular set of one or more items, the second item in the particular set of one or more items comprises selecting, from among the subset of the particular set of one or more items and using the account data, the second item.

4. The computer-implemented method of claim 1, further comprising:
generating, using the account data, the instructions for presentation of information about the second item.

5. The computer-implemented method of claim 1, wherein providing, to the second device, the instructions for presentation of information about the second item comprises providing, to the second device, the instructions for presentation of information about the first item and the second item.

6. The computer-implemented method of claim 1, further comprising:
in response to determining that the image likely shows the first item in the particular set of one or more items, determining to make a recommendation for another item, wherein identifying, from among the particular set of one or more items, the second item as a recommended item in the particular set of one or more items is responsive to determining to make a recommendation for another item.

7. The computer-implemented method of claim 1, wherein determining, based on the device identification information, the particular set of one or more items associated with the first device comprises determining, based on the device identification information, the particular set of one or more items that are available to patrons of a particular establishment with which the first device is registered.

8. The computer-implemented method of claim 1, wherein the user account is an account for a social networking service.

9. The computer-implemented method of claim 8, wherein identifying, from among the particular set of one or more items, the second item in the particular set of one or more items that is different from the first item comprises identifying, from among the particular set of one or more items, the second item in the particular set of one or more items that is different from the first item using data for one or more social networking accounts that are each connected with the user account.

10. The computer-implemented method of claim 8, wherein identifying, from among the particular set of one or more items, the second item in the particular set of one or more items that is different from the first item comprises identifying, from among the particular set of one or more items, the second item in the particular set of one or more items that is different from the first item using activity data for the user account for the social networking service.

11. The computer-implemented method of claim 1, wherein providing, to the second device, instructions for presentation of information about the second item comprises providing, to the first device, instructions for presentation of information about the second item.

12. The computer-implemented method of claim 1, wherein providing, to the second device, instructions for presentation of information about the second item comprises providing, to the second device that is a separate device from the first device, instructions for presentation of information about the second item.

13. The computer-implemented method of claim 1, further comprising receiving, from the first device, data that identifies a particular device to which a system should provide a recommendation for another item, wherein providing, to the second device, instructions for presentation of information about the second item comprises providing, by the system to the particular device, instructions for presentation of information about the second item.

14. The computer-implemented method of claim 13, wherein receiving, from the first device, (i) the device identification information for the first device, (ii) the image that was captured by the first device, and (iii) the account identifier identifying the user account that is associated with the image comprises receiving, by the system, the data that identifies the particular device to which the system should provide a recommendation for another item.

15. A system comprising one or more computers and one or more storage devices storing instructions that are operable, when executed by the one or more computers, to cause the one or more computers to perform operations comprising:
receiving, from a first device, (i) device identification information for the first device, (ii) an image that was captured by the first device, and (iii) an account identifier identifying a user account that is associated with the image;
determining, using the account identifier, account data for the user account;
determining, based on the first device identification information, a particular set of one or more items associated with the first device;
determining, using image recognition with the particular set of one or more items, that the image likely shows a first item in the particular set of one or more items;
using the account data and in response to the determination that the image likely shows the first item in the particular set of one or more items, identifying, from among the particular set of one or more items, a second item in the particular set of one or more items that is different from the first item for which a first attribute value for the first item is the same as a second attribute value for the second item; and
providing, to a second device, instructions for presentation of information about the second item.

16. The system of claim 15, the operations further comprising:
identifying, using the account data for the user account, a subset of the particular set of one or more items, wherein determining, using image recognition with the particular set of one or more items, that the image likely shows the first item in the particular set of one or more items comprises determining, using image recognition with the subset of the particular set of one or more items, that the image likely shows the first item in the subset of the particular set of one or more items.

17. The system of claim 16, wherein identifying, from among the particular set of one or more items, the second item in the particular set of one or more items comprises selecting, from among the subset of the particular set of one or more items and using the account data, the second item.

18. The system of claim 15, the operations further comprising:
generating, using the account data, the instructions for presentation of information about the second item.

19. The system of claim 15, wherein providing, to the second device, the instructions for presentation of information about the second item comprises providing, to the second device, the instructions for presentation of information about the first item and the second item.

20. A computer program product, encoded on one or more non-transitory computer storage media, comprising instructions that when executed by one or more computers cause the one or more computers to perform operations comprising:
receiving, from a first device, (i) device identification information for the first device, (ii) an image that was captured by the first device, and (iii) an account identifier identifying a user account that is associated with the image;
determining, using the account identifier, account data for the user account;
determining, based on the first device identification information, a particular set of one or more items associated with the first device;
determining, using image recognition with the particular set of one or more items, that the image likely shows a first item in the particular set of one or more items;
using the account data and in response to the determination that the image likely shows the first item in the particular set of one or more items, identifying, from among the particular set of one or more items, a second item in the particular set of one or more items that is different from the first item for which a first attribute value for the first item is the same as a second attribute value for the second item; and
providing, to a second device, instructions for presentation of information about the second item.
